(19) United States
(12) Patent Application Publication
(10) Pub. No.: US 2018/0257858 A1
(43) Pub. Date: Sep. 13, 2018

(54) REINFORCED DUMPSTER

(71) Applicant: Rehrig Pacific Company, Los Angeles, CA (US)

(72) Inventors: Shelby Frances Apps, Brookhaven, GA (US); Jon P. Hassell, Atlanta, GA (US); William P. Apps, Alpharetta, GA (US)

(21) Appl. No.: 15/902,192

(22) Filed: Feb. 22, 2018

Related U.S. Application Data
(60) Provisional application No. 62/462,597, filed on Feb. 23, 2017.

(51) Int. Cl. B65F 1/14; B65F 1/12

(52) U.S. Cl. CPC B65F 1/1426; B65F 1/122

(57) ABSTRACT

A container includes a base and a plurality of walls extending upward from the base to define a container interior. A pair of opposed side walls extend inward from one of the plurality of walls to an inner wall to define a recess on an exterior of the container. A pair of inner supports are disposed in the interior of the container. The inner supports abut the side walls. A grab bar is connected to the pair of inner supports and extends from one of the side walls to the other of the side walls across the recess. The inner supports are part of a reinforcement frame that includes an upper portion encircling upper edges of the plurality of walls below a lip.

### BACKGROUND

Metal commercial waste containers (or dumpsters) have been used for a long time. Metal containers are heavy, noisy and subject to rust and dents. Plastic containers are lighter, quieter and do not rust or dent but have not been compatible with certain semi-automatic lifters on some waste hauling trucks.

### SUMMARY

A commercial waste container includes a base and a plurality of walls extending upward from the base to define a container interior. A pair of opposed side walls extend inward from one of the plurality of walls to an inner wall to define a recess on an exterior of the container. A pair of inner supports are disposed in the interior of the container. The inner supports abut the side walls on either side of the recess. One or more grab bars are connected to the pair of inner supports and extend from one of the side walls to the other of the side walls across the recess.

The inner supports may be part of a reinforcement frame that includes an upper portion encircling upper edges of the plurality of walls below a lip. The inner supports may be connected to the upper portion of the reinforcement frame by fasteners extending through the wall of the container. Lifters that grab onto the grab bars will transmit lifting forces through the reinforcement frame, i.e. through the grab bars to the inner supports to the upper portion, which distributes these forces to all of the container walls and the lip.

### BRIEF DESCRIPTION OF THE DRAWINGS

FIG. 1 is a perspective view of a container according to a first embodiment.

FIG. 2 is a front view of the container.

FIG. 3 is a rear view of the container.

FIG. 4 is a top view of the container.

FIG. 5 is a bottom view of the container.

FIG. 6 is a first end view of the container.

FIG. 7 is a second end view of the container.

FIG. 8 is a section view through the container looking toward the interior of the first end wall.

FIG. 9 is a perspective view looking down toward an end wall into the container body without the reinforcement frame.

FIG. 10 is a view similar to that of FIG. 9, but including the reinforcement frame.

FIG. 11 is a section view through the container looking toward the rear wall.

FIG. 12 is a perspective view of the reinforcement frame.

FIGS. 13-15 show trunnion bar halves being inserted into the metal tube in the lip of the container.

FIG. 16 shows the metal tube exploded from the container.

FIG. 17 is a section view through the lip showing the metal tube inside the lip.

FIG. 18 is the same section view as FIG. 17, with the trunnion bar halves received in the lip.

FIG. 19 shows the container with optional plastic lids.

FIG. 20 is a top view of the container with lids of FIG. 19.

FIG. 21 is a front view of the container with the lids of FIG. 19.

FIG. 23 sis an end view of the container with lids being nested with an identical container with lids.

FIG. 24 is a front view of the containers of FIG. 23.

FIG. 25 is a perspective view of the containers of FIG. 23.

### DETAILED DESCRIPTION OF A PREFERRED EMBODIMENT

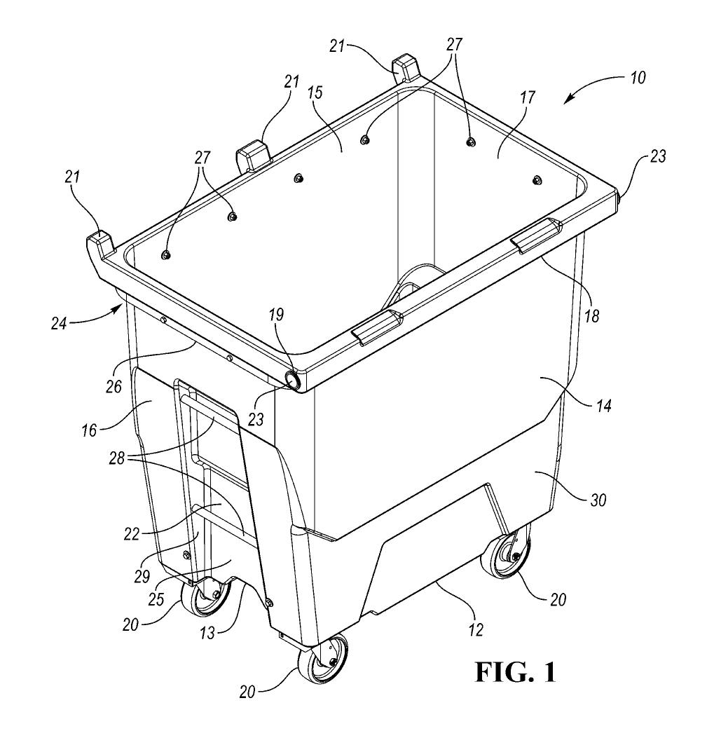

A container 10 for receiving waste or recycling is shown in FIG. 1. The container 10 is generally a smaller commercial-size dumpster, such as a ¾ yard or 1 yard dumpster (approximate internal volume) but features described herein are applicable to other size commercial containers as well. The container 10 includes a base 12, front wall 14, rear wall 15 and opposed first and second end walls 16, 17. The base 12 may include a pair of upwardly-convex portions 13 (one shown), extending generally parallel to the front wall 14 and rear wall 15. At the upper edges of the walls 14, 15, 16, 17 is a lip 18 projecting outward. A plurality of lugs 21 project upward and rearward from the lip 18 above the rear wall 15. The base 12, walls 14, 15, 16, 17, lip 18 and lugs 21 may be integrally molded as a single piece of plastic, such as by rotomolding. A plurality of casters 20 may support the base 12.

A generally cylindrical metal tube 19 is inserted through the lip 18 above the front wall 14 after molding (or optionally may be insert-molded). The metal tube 19 may be secured in place directly to the lip 18 (via fasteners, not shown) and/or washers 23 welded to outer ends of the metal tube 19 after insertion.

The first end wall 16 includes a large recess 22 formed therein, with an inner wall 25 at the back of the large recess 22 and side walls 29 (only one visible in FIG. 1) extending inward from the first end wall 16. The recess 22 occupies approximately a middle 30 to 50% of the first end wall 16 in the lateral dimension and approximately 60 to 80% of the height of the first end wall 16. The recess 22 is open to the bottom of the container 10 adjacent the base 12. The recess 22 is wider at the bottom and tapers up to the top of the recess 22 to facilitate nesting.

All of the walls 14, 15, 16, 17 of the container 10 are tapered toward the bottom and in this example have a lower portion that is offset inward to form a lower tapered portion 30 of the container 10. This facilitates nesting of identical containers when empty.

A reinforcement frame 24 is provided to reinforce the container 10 especially during lifting by handling equipment such as semi-automated lifters on waste and recycling collection trucks. The reinforcement frame 24 includes an upper portion 26 that encircles the upper edge of the walls 14, 15, 16, 17 just below the lip 18. The upper portion 26 may be formed by metal tubular structures that are secured to the walls 14, 15, 16, 17 and/or lip 18, such as by fasteners 27. The reinforcement frame 24 also includes upper and lower catch bars 28 that may also be tubular metal structures. The upper and lower catch bars 28 extend horizontally completely across the large recess 22 formed in the first end wall 16 from one side wall 29 to the other side wall 29. The upper catch bar 28 is spaced above the lower catch bar 28.

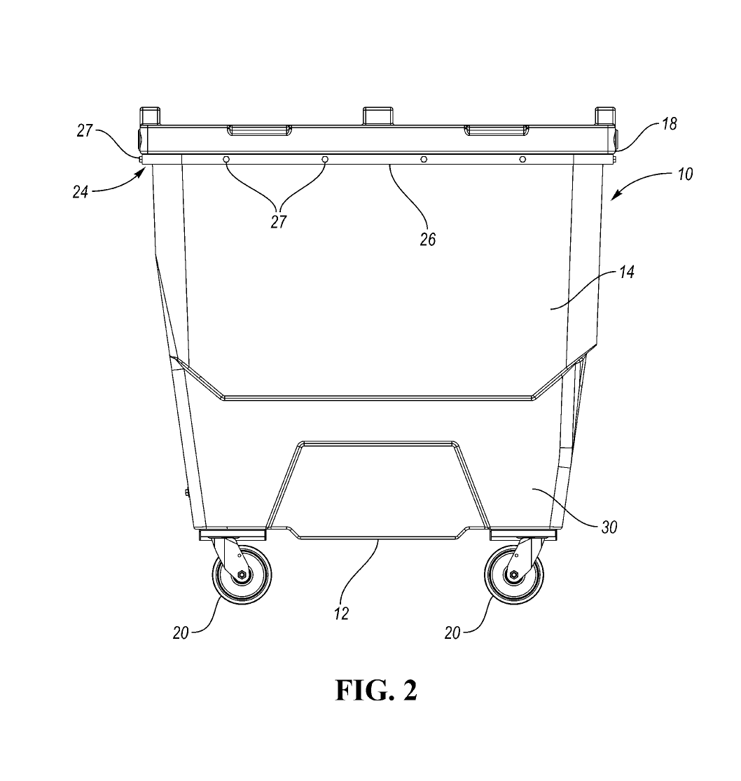

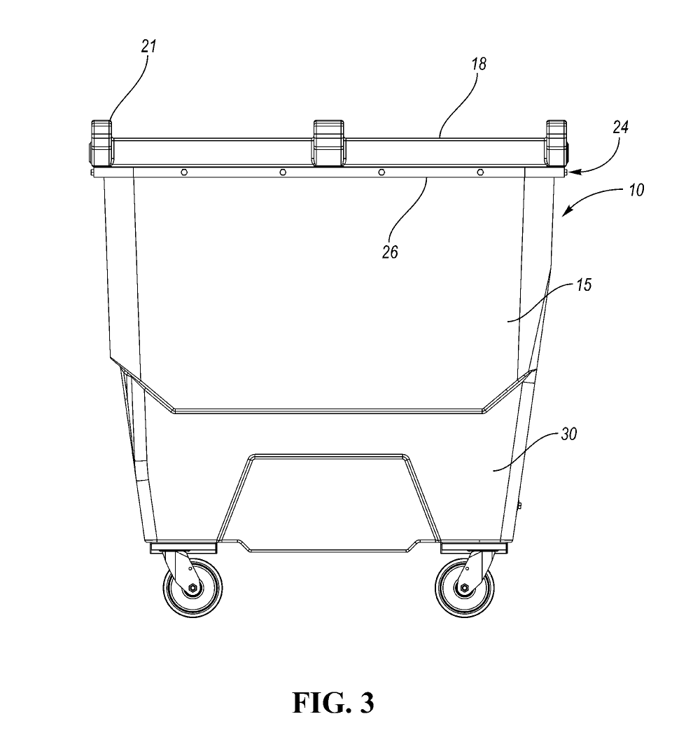

FIG. 2 is a front view of the container 10. The upper portion 26 of the reinforcement frame 24 abuts the lip 18 and the front wall 14. As shown, the upper portion 26 of the reinforcement frame 24 is recessed away from the outermost edge of the lip 18. This helps prevent damage to walls or doorframes in buildings. Likewise, as shown in FIG. 3, the upper portion 26 of the reinforcement frame 24 abuts the lip 18 and the rear wall 15.

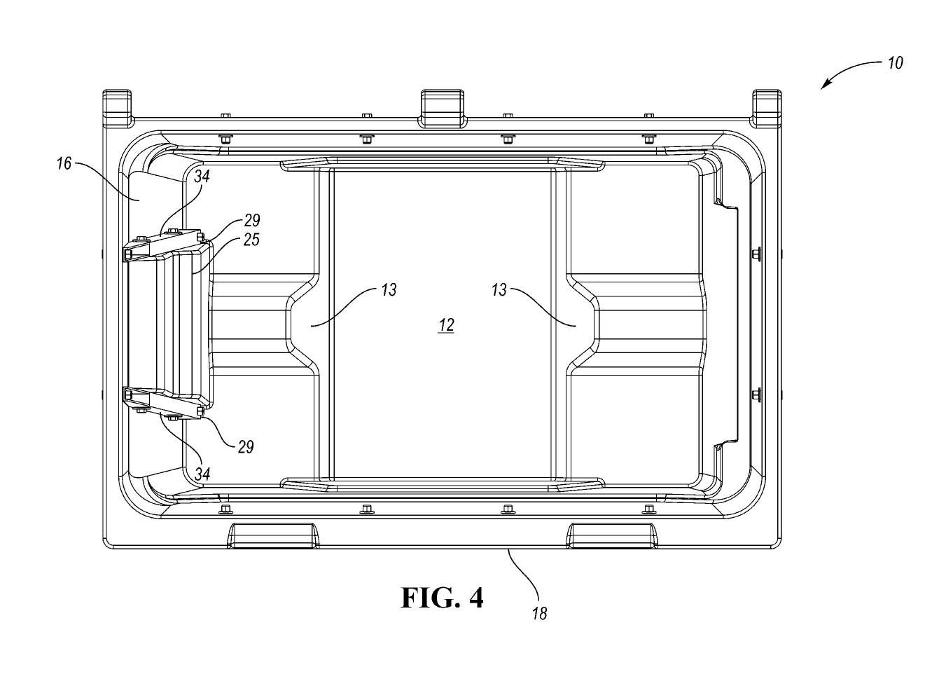

FIG. 4 is a top view of the container 10. As shown in FIG. 4, the first end wall 16 has a pair of inner supports 34 secured to the side walls 29 adjacent the rear wall 25 that defines the recess 22 (FIG. 1). The inner supports 34 are secured to the upper portion 26 of the reinforcement frame 24 (FIG. 1) by connectors passing through the first end wall 16. The inner supports 34 may be metal, hollow and rectangular in cross section.

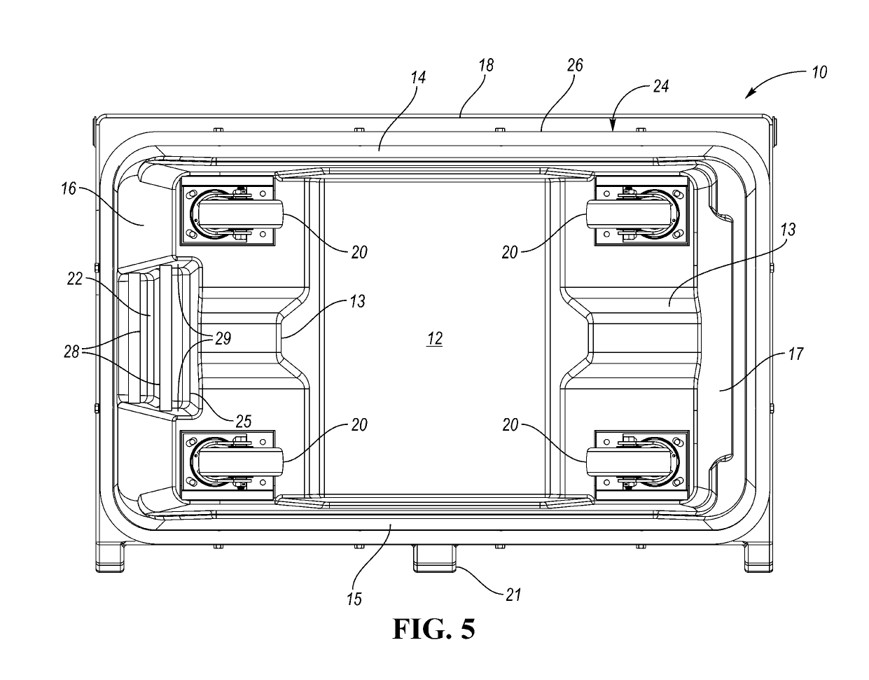

FIG. 5 is a bottom view of the container 10. The upper and lower catch bars 28 extend across the recess 22 from one side wall 29 to the other side wall 29. The upper portion 26 of the reinforcement frame 24 extends completely and continuously around the perimeter of the upper edges of the front wall 14, rear wall 15 and opposed end walls 16, 17 below the lip 18.

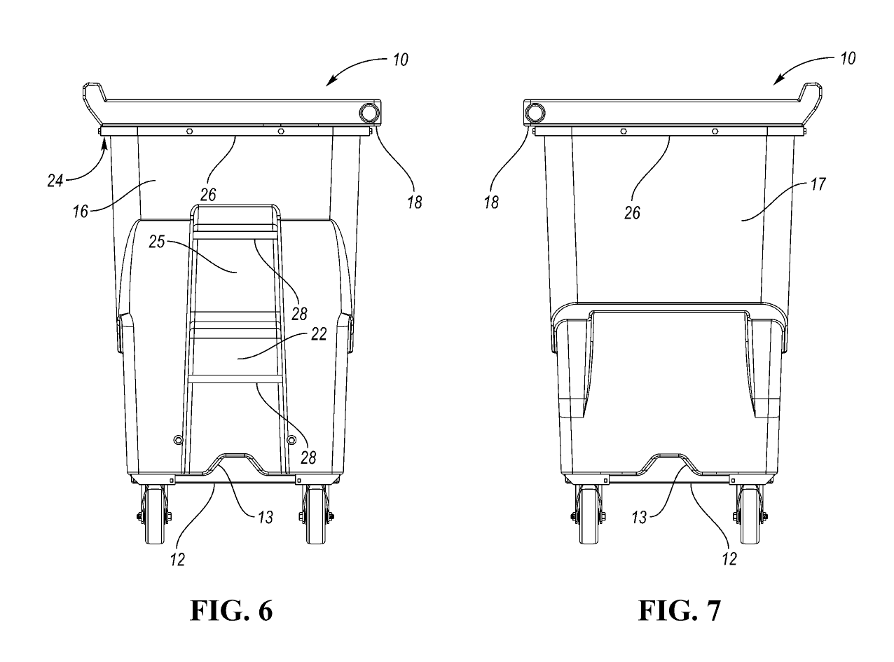

FIG. 6 is an end view of the first end wall 16 of the container 10. FIG. 7 is an end view of the second end wall 17 of the container 10.

FIG. 8 is a section view through the container 10 looking toward the interior of the first end wall 16. As can be seen in FIG. 8, the inner supports 34 are secured by fasteners 40 to the side walls 29 that define the large recess 22 (on the exterior, see FIG. 1) and to the end wall 16. The inner supports 34 are angled toward one another at the upper ends thereof. FIG. 8 also shows a section of the metal tube 19 received in the lip 18 (which is hollow) along the top of the front wall 14.

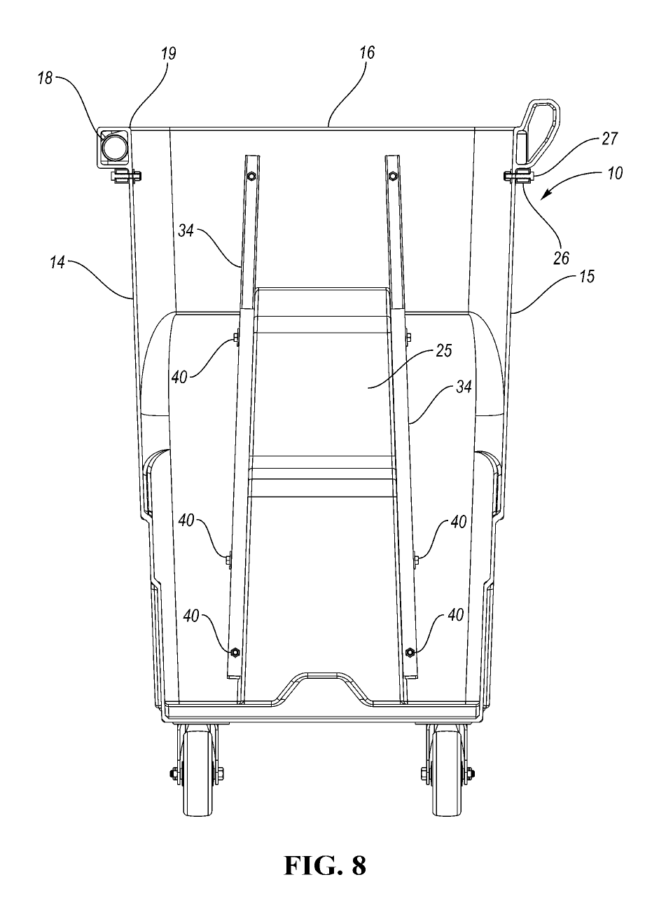

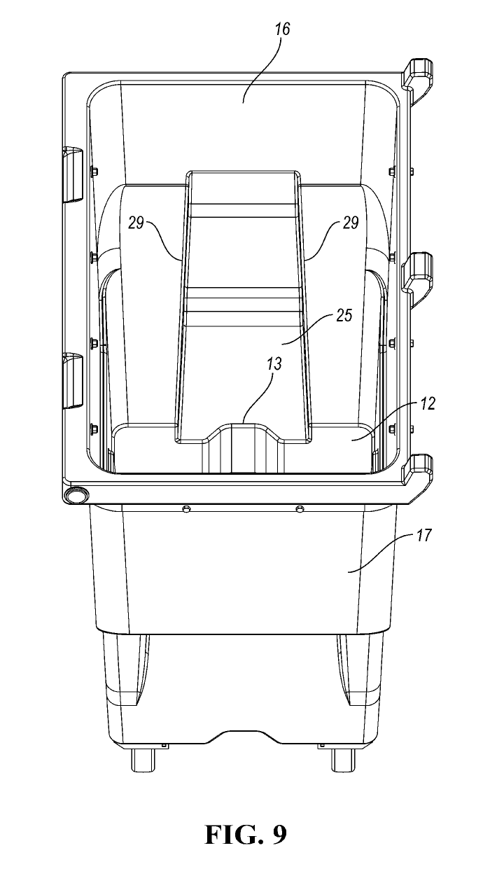

FIG. 9 is a perspective view looking down toward the end wall 16 into the container body without the reinforcement frame 24. The side walls 29 angle inwardly toward one another as they extend upward from the base 12.

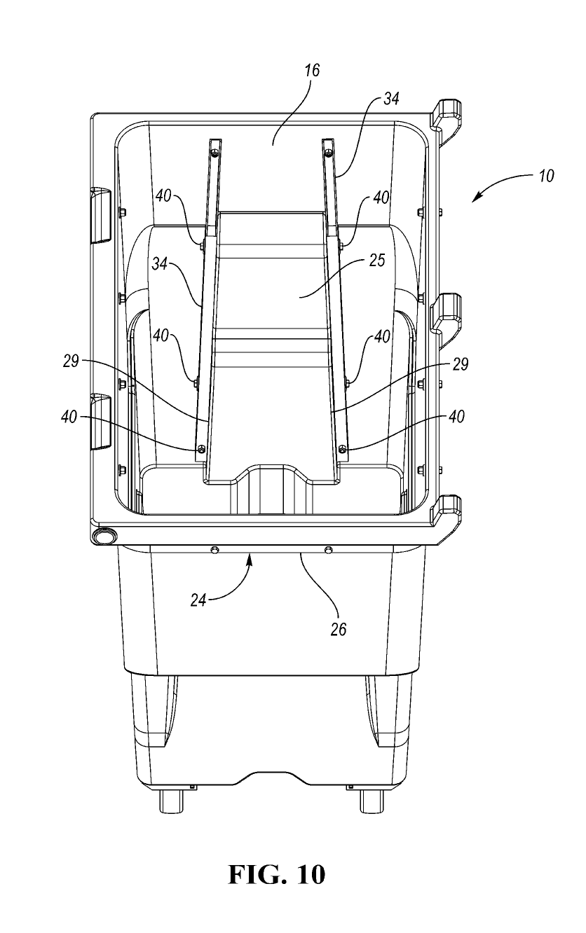

FIG. 10 is a view similar to that of FIG. 9, but also including the reinforcement frame 24. The reinforcement frame 24 includes the upper portion 26 below the lip 18 and the two inner supports 34. The inner supports 34 are secured to the side walls 29 via fasteners 40.

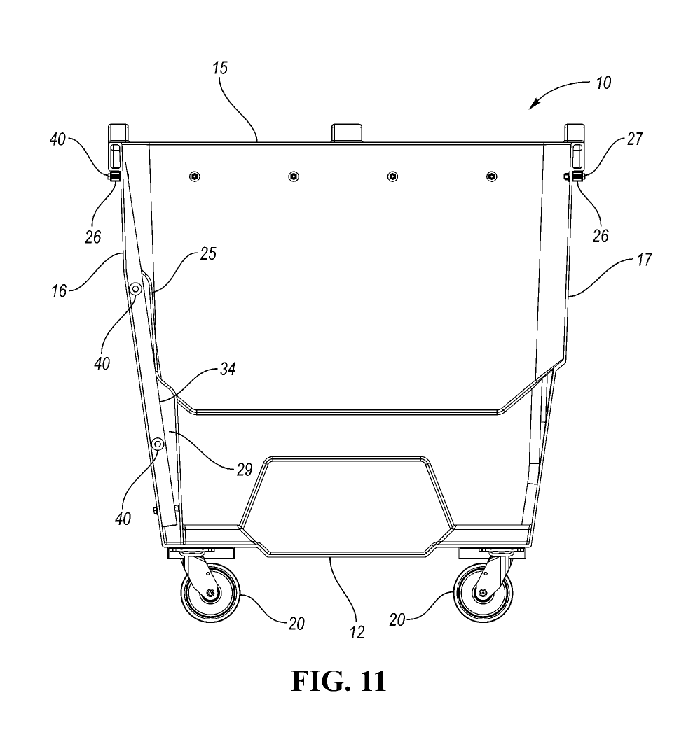

FIG. 11 is a section view through the container 10 looking toward the rear wall 15, showing one of the inner supports 34 secured to the side wall 29 by fasteners 40. Another fastener 40 secures the inner support 34 to the upper portion 26 through the first end wall 16 just below the lip 18.

FIG. 12 is a perspective view of the reinforcement frame 24. The upper portion 26 is generally rectangular with rounded corners. The upper ends of the inner supports 34 are secured to one end of the upper portion 26 (through the end wall 16, not shown).

After the body of the container 10 is molded (e.g. FIG. 9), the upper portion 26 is slid under the lip 18 or assembled in place. A plurality of fasteners 27 secure the upper portion 26 to the walls of the container below the lip 18. The inner supports 34 are then placed in the container 10 against the side walls 29 and secured to the side walls 29, the end wall 16 and the upper portion 26 (e.g. FIG. 11). The upper and lower catch bars 28 (FIG. 1) are then secured to the side walls 29 on the exterior of the first end wall 16 in the large recess 22 with fasteners 40 extending through the side walls 29 to the inner supports 34 (FIG. 8).

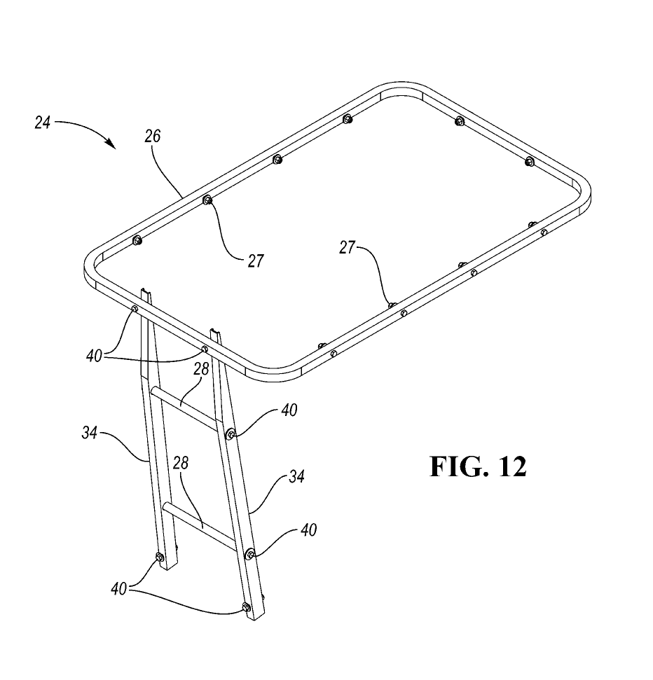

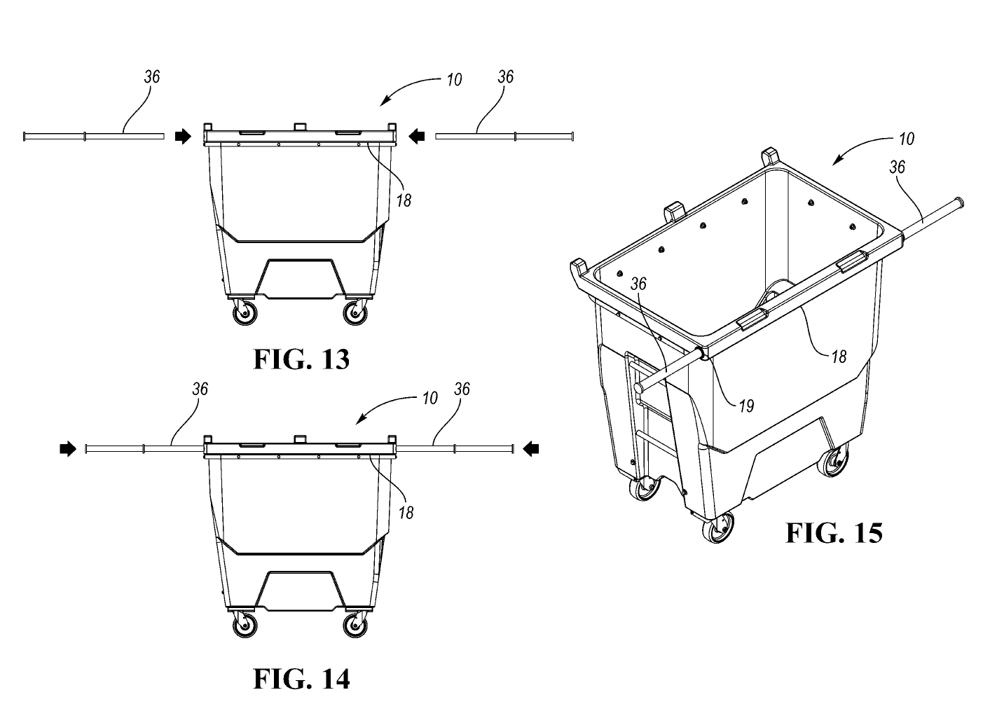

FIGS. 13-15 show trunnion bar halves 36 being inserted into the metal tube 19 in the lip 18. Generally, the container 10 may be shipped and then filled over time without the trunnion bar halves 36 in place. This reduces the space required during shipping, storage and use and avoids damages to walls or doorways during use and transport in and out of a building or shed. To empty the container 10 into a truck requiring a trunnion bar, the container 10 is brought to the rear of the truck and then the trunnion bar halves 36 are inserted as shown. When the trunnion bar halves 36 are in place, a truck with a rear load kickbar configuration can empty the container 10 into the truck. The trunnion bar halves 36 can then be removed and the container 10 returned to its location for filling (e.g. inside a building or shed). The trunnion bar halves 36 may be carried in the truck for use with multiple containers 10 at different locations.

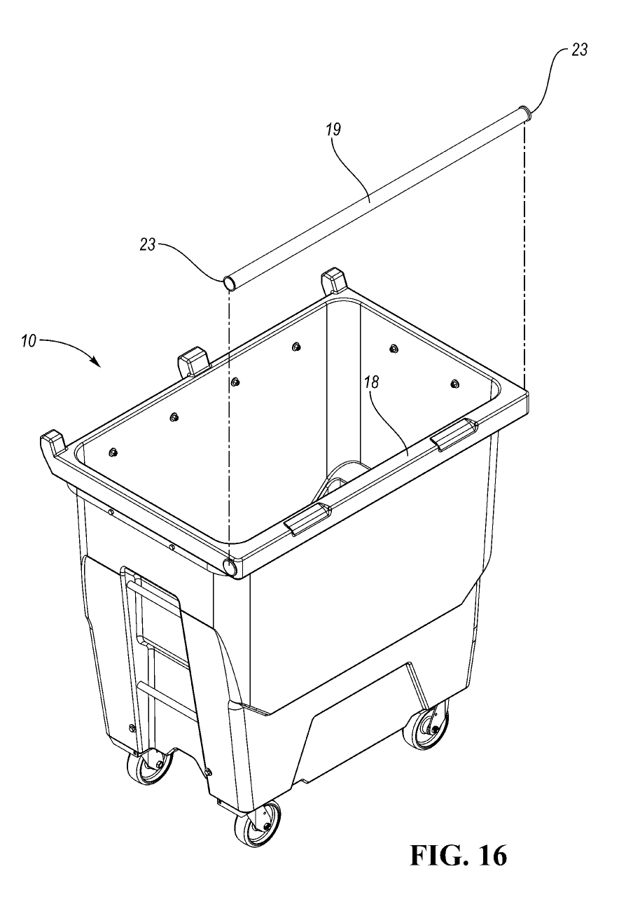

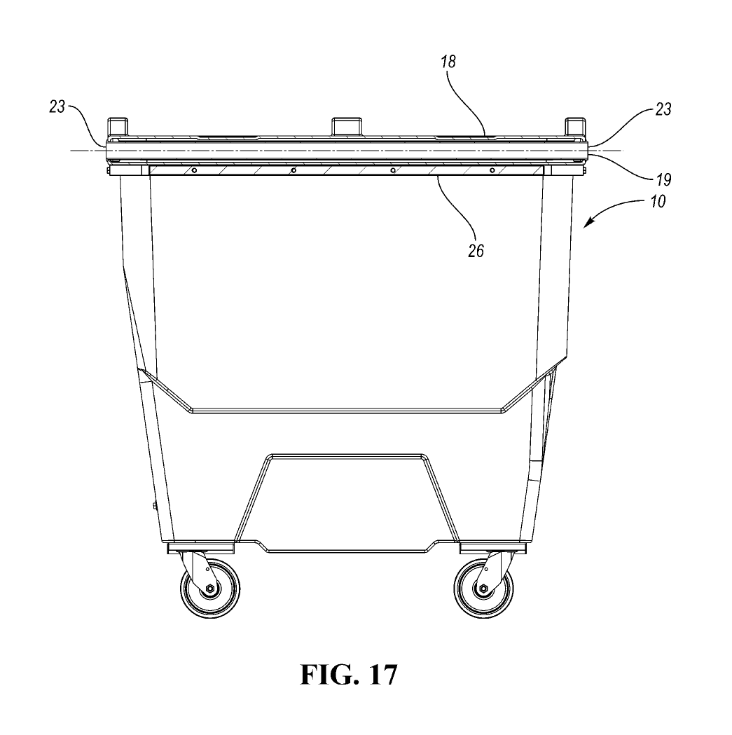

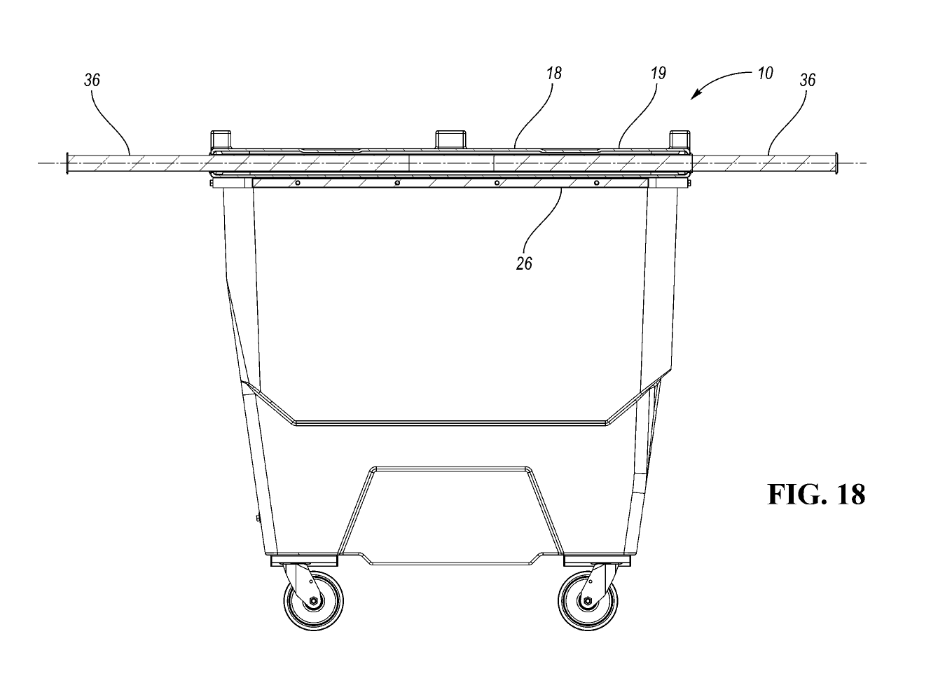

FIG. 16 shows the metal tube 19 exploded from the container 10, with the washers 23 (installed after insertion) on the ends of the metal tube 19. FIG. 17 is a section view through the lip 18 showing the metal tube 19 inside the lip 18, with washers 23 welded to ends of the metal tube 19 to retain the metal tube 19 inside the lip 18. FIG. 18 is the same section view as FIG. 17, with the trunnion bar halves 36 received in the lip 18, inside the metal tube 19.

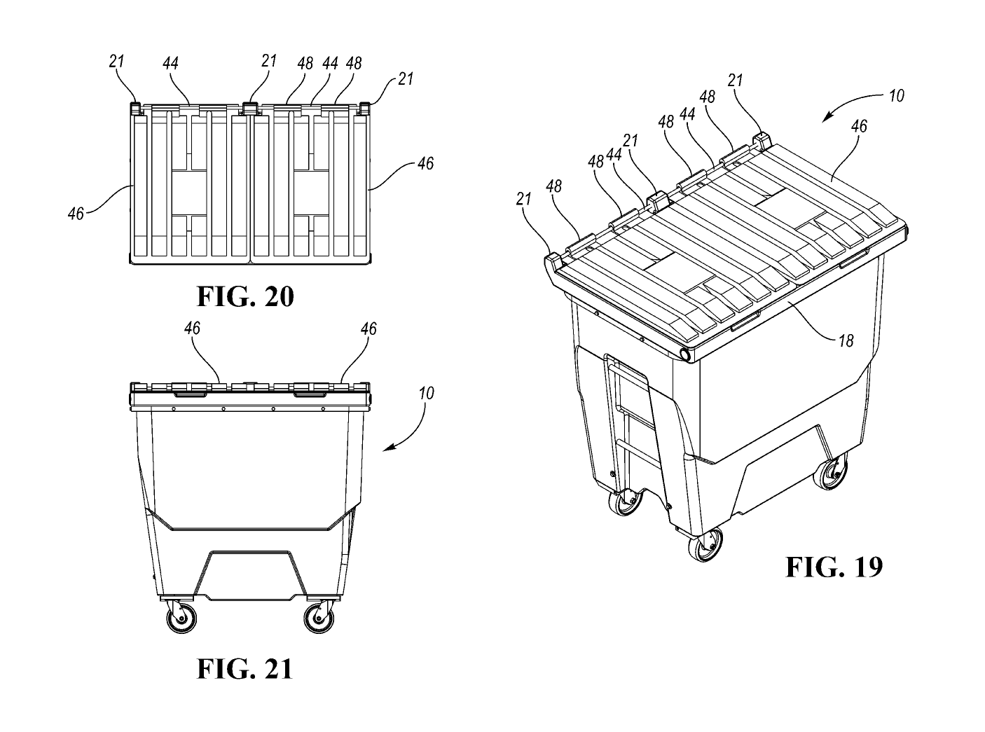

FIG. 19 shows the container 10 with optional plastic lids 46, each covering half the container 10. The lids 46 are secured to the lugs 21 on the rear wall 15 of the container 10 by an elongated rod 44. The rod 44 extends through the lugs 21 and through hinge portions 48 of the lids 46. FIGS. 20 and 21 are top and front views of the container 10 with the lids 46.

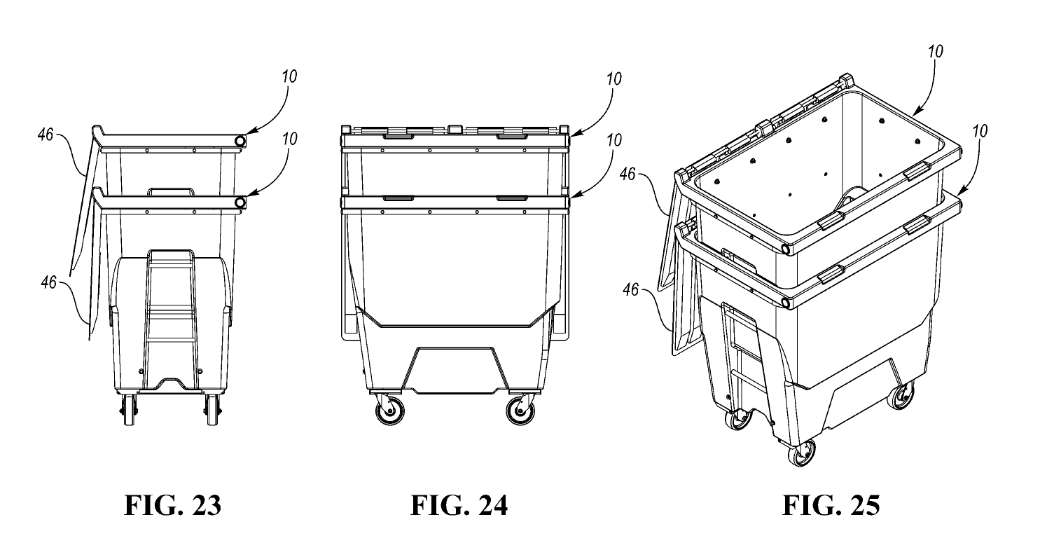

FIGS. 23-25 show the container 10 being nested with an identical container 10. The reinforcement frame 24 does not interfere with the nestability of the containers 10. The lids 46 can be pivoted to their open position while nested within one another. This provides for efficient shipping and storage of empty containers 10.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A container comprising:
a base;
a plurality of walls extending upward from the base to define a container interior; and
a reinforcement frame including an upper portion secured to at least one of the plurality of walls.

2. The container of claim 1 wherein the plurality of walls includes a front wall and an opposed rear wall.

3. The container of claim 1 wherein the reinforcement frame further includes a grab bar on an exterior of the container, the grab bar connected to the upper portion of the reinforcement frame.

4. The container of claim 1 wherein the upper portion of the reinforcement frame is a continuous ring encircling upper portions of the plurality of walls.

5. The container of claim 4 further including a lip protruding outward from the upper portions of the plurality of walls, the upper portion of the reinforcement frame positioned below lip.

6. The container of claim 5 wherein the reinforcement frame includes at least one inner support in the interior of the container, wherein the reinforcement frame further includes a grab bar on an exterior of the container, wherein the grab bar is connected to the at least one inner support.

7. The container of claim 6 wherein the base and plurality of walls are integrally molded as a single piece of plastic and wherein the reinforcement frame is metal.

8. The container of claim 7 wherein the at least one inner support includes a pair of inner supports and wherein the grab bar is secured between the pair of inner supports.

9. The container of claim 8 wherein the pair of inner supports are secured to the upper portion of the reinforcement frame by at least one fastener extending through at least one of the plurality of walls.

10. The container of claim 9 wherein the pair of inner supports are each secured to one of a pair of opposed side walls extending inward from the at least one of the plurality of walls.

11. The container of claim 10 wherein the lip is hollow.

12. The container of claim 11 further including a metal tube inside the lip, the metal tube open at opposite ends of the container.

13. The container of claim 12 further including a pair of trunnion bars removably inserted into open ends of the metal tube and projecting outward of the metal tube.

14. The container of claim 1 wherein the interior of the container is approximately ¾ to 1 cubic yard.

15. The container of claim 14 wherein the base and plurality of walls are rotomolded as a single piece of plastic.

16. The container of claim 1 further including a plurality of lugs protruding from upper edges of one of the plurality of walls, at least one lid hingeably secured to the plurality of lugs.

17. A container comprising:
a base;
a plurality of walls extending upward from the base to define a container interior;
a lip formed at upper edges of the plurality of walls; and
a metal tube inside the lip, the metal tube having openings at opposite ends of the container.

18. The container of claim 15 further including a pair of trunnion bars removably inserted into open ends of the metal tube and projecting outward of the metal tube.

19. The container of claim 16 wherein the interior of the container is approximately ¾ to 1 cubic yard.

20. A container comprising:
a base;
a plurality of walls extending upward from the base to define a container interior;
a pair of opposed side walls extending inward from a first wall of the plurality of walls to an inner wall to define a recess on an exterior of the container;
a pair of inner supports in the interior of the container, the inner supports abutting the side walls; and
at least one bar connected to the pair of inner supports and extending from one of the side walls to the other of the side walls across the recess.
